(19) United States
(12) Patent Application Publication
(10) Pub. No.: US 2023/0095248 A1
(43) Pub. Date: Mar. 30, 2023

(54) DISPLAY SYSTEM HAVING ITEM DISPLAY TRANSITION FUNCTION

(71) Applicant: FANUC CORPORATION, Yamanashi (JP)

(72) Inventor: Teppei HOSHIYAMA, Yamanashi (JP)

(21) Appl. No.: 17/904,293

(22) PCT Filed: Feb. 12, 2021
(86) PCT No.: PCT/JP2021/005333

§ 371 Date: Aug. 16, 2022

(30) Foreign Application Priority Data
Feb. 19, 2020 (JP) 2020-026213

(51) Int. Cl. G06F 3/0482; G06F 3/0484

(52) U.S. Cl. CPC G06F 3/0482; G06F 3/0484

(57) ABSTRACT

This display system comprises: a display unit for displaying a screen for a setting or a status check; a storage unit for storing a dictionary file corresponding to a display language displayed on the display unit; and an item display transition unit for causing, on the basis of the dictionary file, a display of an item in a particular part on the screen to transition to another message expressed in the stored display language.

### TECHNICAL FIELD

The present invention relates to a display system, and in particular, relates to a display system having an item display transition function.

### BACKGROUND ART

In general, teaching and status checking of an industrial robot are performed from a teaching pendant which can communicate with a robot controller, while the setting and status checking of a machine tool are performed from an operation panel which can communicate with a numerical controller. In a display system represented by such an operation panel, the location where the machine is used is limited, and the memory capacity for storing dictionary files of each language is insufficient. Thus, in many cases, only the minimum required languages are stored in the memory in advance and displayed. The following literature is known as prior art relating to such a display system.

Patent Literature 1 describes a display operation device for a machine tool, wherein display for language selection is performed, and the language to be displayed can appropriately be changed by selecting a language.

Patent Literature 2 describes a robot teaching device, wherein a language change key which can be operated at all times is provided on a touch panel, and the display language of a display unit is changed based on operation of the language change key.

Patent Literature 3 describes that since an operation may mistakenly be performed if the name of an operation key printed on an operation device is not expressed in the language used by the operator, guide information is output to a display unit to guide the name of the operation key in the native language of the operator.

### CITATION LIST

### Patent Literature

[PTL 1] JP 1996(H08)-179817 A

[PTL 2] JP 2001-088069 A

[PTL 3] JP 2013-111663 A

### SUMMARY OF INVENTION

### Technical Problem

If a user is unfamiliar with a display language, they may not know where to change the display language or may make a mistake. Conversely, even if the user is accustomed with the display language, it may not be possible to reach the display language change location due to the screen configuration. Furthermore, users are generally restricted from accessing items in specific locations, but if they do not understand the display language, it will not be easy to understand whether or not access is restricted.

Particularly in the display systems of machines and business management, an item in a specific location is often expressed in terminology, so if the display language is unfamiliar, a beginner will not be able to understand the content of item even more. Furthermore, even an expert may not understand the display language and may perform an operation erroneously. In particular, when a setting related to the operation of the machine is unintentionally changed, it is very dangerous because it may impact not only the workpiece but also humans. Furthermore, particularly in the operation panel of a machine, since the space in the existing menu screen is limited, if a display language change setting, etc., is provided on a top screen, the screen will be overwhelmed, which will reduce the convenience of the user.

There is a demand for display technology that supports the user understanding of items in specific locations regardless of the display language to suppress erroneous operations.

### Solution to Problem

One aspect of the present disclosure provides a display system comprising a display unit for displaying a screen for performing setup or a status check, a storage unit in which there is stored a dictionary file corresponding to display languages for display on the display unit, and an item display transition unit for transitioning display of an item in a specific location on the screen to another message expressed in the stored display language.

### Advantageous Effects of Invention

According to the aspect of the present disclosure, it is possible to support the understanding of a user of the item in the specific location and suppress erroneous operations regardless of the display language. Particularly in the operation panel of a machine, the location where it is used is limited, and the number of display languages is generally limited. Thus, the item display transition function improves the convenience of the user.

### BRIEF DESCRIPTION OF DRAWINGS

FIG. 1 is a schematic view showing a schematic configuration of a display system of an embodiment.

FIG. 2 is a block diagram showing a detailed structure of the display system.

FIG. 3 is a view showing an example of a screen displayed before reaching a display language change setting.

FIG. 4 is a view showing an example of a screen displayed before reaching a display language change setting.

FIG. 5 is a view showing an example of a screen displayed in the process of a user frames setting.

FIG. 6 is a view showing an example of a screen displayed in the process of a user frames setting.

FIG. 7 is a view showing an example of a screen for a user to login.

### DESCRIPTION OF EMBODIMENTS

The embodiments of the present disclosure will be described in detailed below with reference to the attached drawings. In the drawings, identical or similar constituent elements have been assigned the same or similar reference signs. Furthermore, the embodiments described below do not limit the technical scope of the invention or the definitions of the terms described in the claims.

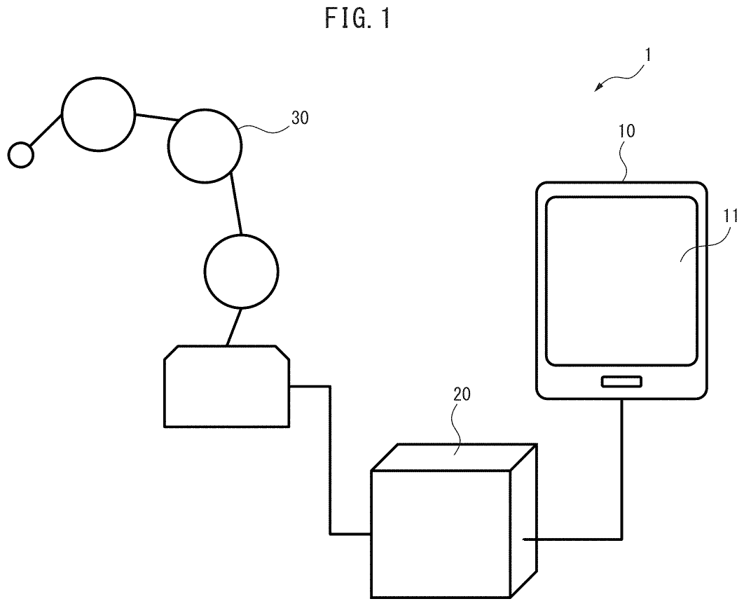

FIG. 1 shows the schematic structure of a display system 1 according to the present embodiment. Though the display system 1 is a display system for performing setup or status check of a machine such as a robot, machine tool, or industrial machine, it may be a display system for performing setup or status check of business management such as sales management, production management, or accounting management. For example, though the display system 1 comprises an operation panel 10 for performing an operation of a machine, a controller 20 which is wired or wirelessly connected to the operation panel 10 for controlling the machine, and a machine 30 which is controlled by the controller 20, it may comprise an operation panel 10 for performing a business management operation, and a controller 20 which is wired or wirelessly connected to the operation panel 10 for performing business management. The operation panel 10 and controller 20 comprise a processor such as a CPU (central processing unit), and memory such as RAM (random access memory) or ROM (read-only memory). The operation panel 10 comprises a display unit 11 which displays a screen for performing setup or a status check, and for example, the display unit 11 may be a touch panel comprising a display panel such as a liquid crystal or organic EL (electro-luminescence) display.

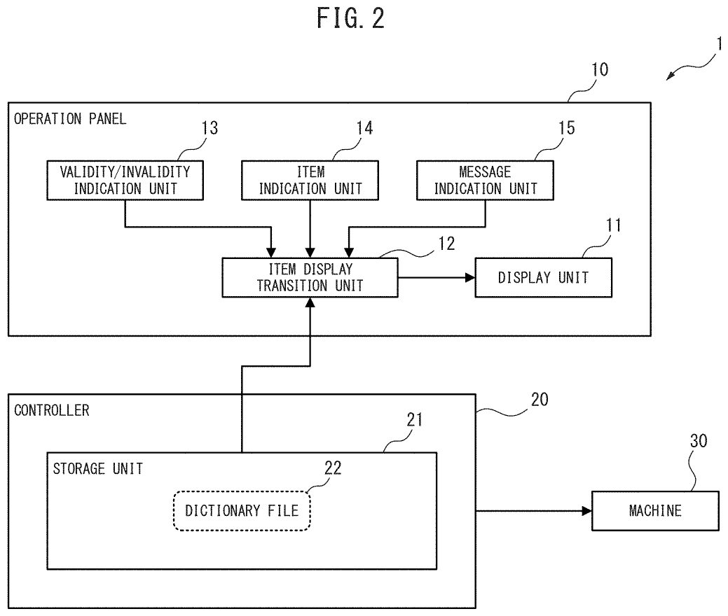

FIG. 2 shows the detailed structure of the display system 1. The display system 1 comprises a storage unit 21 in which there is stored a dictionary file 22 corresponding to the display languages displayed on the display unit 11. For example, though the storage unit 21 may be memory of the controller 20, it may be memory of the operation panel 10 or may be memory of an external storage device. The dictionary file 22 is dictionary data in which item names are expressed in various languages in accordance with an item ID on the screen, as illustrated by, for example, the following table. According to this dictionary file 22, when the currently selected display language is Japanese, the character string “ [symbol] ” is displayed at the item ID “0001” of a certain screen, and when the currently selected display language is English, the character string “SETUP” is displayed at the item ID “0001” of the certain screen.

TABLE 1

| Item ID | Japanese | English |
|---|---|---|
| 0001 | [symbol] | SETUP |
| 0002 | [symbol] | GENERAL |
| 0003 | [symbol] | CURRENT |
| | | LANGUAGE |
| . | . | . |
| . | . | . |
| . | . | . |

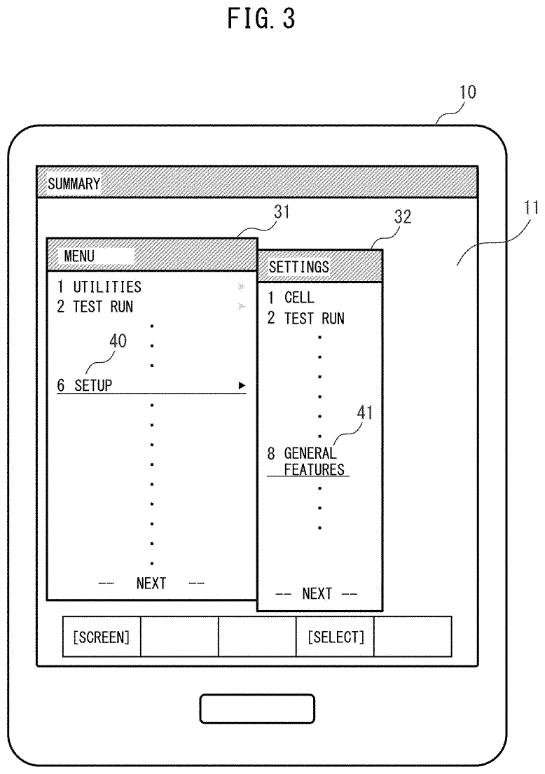

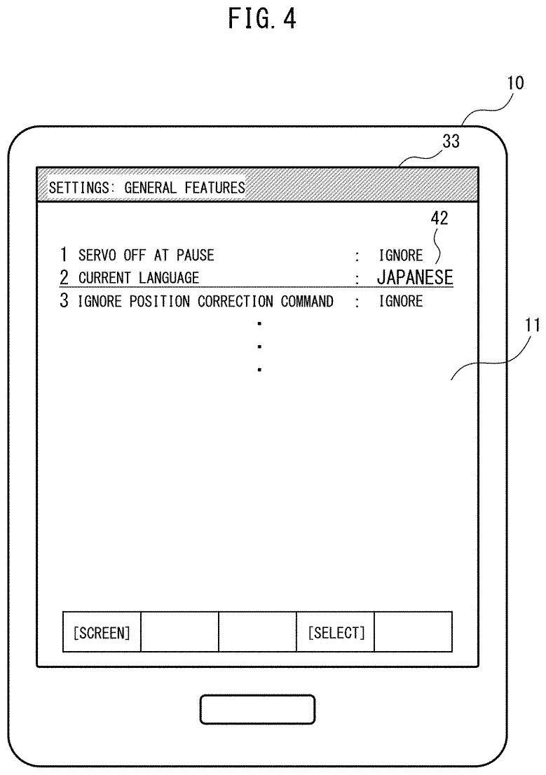

FIGS. 3 and 4 show an example of a screen displayed before reaching a display language change setting. When a “SETUP” item 40 of a menu screen 31 shown in FIG. 3 is selected, a setting menu screen 32 is displayed, when a “GENERAL FEATURES” item 41 of the setting menu screen 32 is selected, a general features setting screen 33 shown in FIG. 4 is displayed, and by selecting an item 42 “CURRENT LANGUAGE” of the general features setting screen 33, the display language can be changed. Specifically, items 40 to 42 are items related to display language change settings.

When the currently selected display language (Japanese) is unfamiliar to the user, they may not understand the display language change location. Furthermore, even when the currently selected display language (Japanese) is familiar to the user, it may not be possible to reach the display language change location due to the screen configuration. In such a case, the user may make an erroneous operation, leading to an unexpected accident.

Referring again to FIG. 2, the display system 1 comprises an item display transition unit 12 which transitions the display of an item in a specific location on the screen to another message expressed in a stored display language (for example, Japanese, English, etc.) based on the dictionary file 22. Though the function of the item display transition unit 12 is executed by the processor of the operation panel 10, it may be executed by the processor of the controller 20 or the processor of an external computing device. The item display transition unit 12 transitions the display of the “SETUP” item 40, “GENERAL FEATURES” item 41, and “CURRENT LANGUAGE” item 42 for the plurality of screens 31 to 33 for reaching the display language change setting to another message (for example “ [symbol] ” or “CHANGE LANGUAGE IS HERE”, etc.) expressed in a stored display language (for example, Japanese, English, etc.) based on the dictionary file 22, as illustrated by, for example, the following table.

TABLE 2

| | | | Japanese | | |
|---|---|---|---|---|---|
| Item ID | Japanese | English | message | English Message | ... |
| 0001 | [symbol] | SETUP | [symbol] | CHANGE | ... |
| | | | | LANGUAGE | |
| | | | | IS HERE | |
| 0002 | [symbol] | GENERAL | [symbol] | CHANGE | ... |
| | | | | LANGUAGE | |
| | | | | IS HERE | |
| 0003 | [symbol] | CURRENT | [symbol] | CHANGE | ... |
| | | LANGUAGE | | LANGUAGE | |
| | | | | IS HERE | |
| . | . | . | . | . | . |
| . | . | . | . | . | . |
| . | . | . | . | . | . |

When there is a user which is unfamiliar with the currently selected display language (for example, Japanese) but which is familiar with a language (for example, English) different from the display language (for example, Japanese), the item display transition unit 12 may transition the display (for example, in Japanese) of items 40 to 42 in the specific locations to another message (“CHANGE LANGUAGE IS HERE”, etc.) expressed in a display language (for example, English, etc.) different from that of items 40 to 42. For example, the display of the “SETUP” item 40 can be changed at a fixed interval so as to display “ [symbol] ”→“CHANGE LANGUAGE IS HERE”→“ [symbol] ” . . . , etc. As a result, even for users who are unfamiliar with the currently selected display language (for example, Japanese) but who are accustomed with a language (for example, English) different from the display language (for example, Japanese), it is possible to reach the display language change location.

Furthermore, if the native languages of the users are diverse (for example, Japanese, English, French, etc.), the item display transition unit 12 preferably transitions the display of each of the “SETUP” item 40, the “GENERAL FEATURES” item 41, and the “CURRENT LANGUAGE” item 42 to other messages successively, which are expressed in all of the stored display languages, i.e., the displayable display languages (for example, “ [symbol] ”, “CHANGE LANGUAGE IS HERE”, “CLIQUEZ ICI POUR CHANGER DE LANGUE”, etc.). For example, the “SETUP” item 40 can be changed at a fixed interval to a message in each of the display languages, such as “ [symbol] ”→“ [symbol] ”→“CHANGE LANGUAGE IS HERE”→“CLIQUEZ ICI POUR CHANGER DE LANGUE”→“SETUP”, etc. As a result, even if the user is unfamiliar with the currently selected display language (for example, Japanese), or if the user is accustomed with the display language (for example, Japanese) but simply does not know where to change the display language, it is possible to reach the display language change location.

Since many display languages are stored in the case of general PCs (personal computers), smartphones, tablets, etc., if the item is transitioned to other messages expressed in all of the display languages which can be displayed in order, it takes time for the message in the language to which the user is accustomed to be displayed, which reduces the convenience for the user. However, in machine and business management display systems, since usage locations are limited and the number of display languages is limited to some extent, such an item display transition function can support the understanding of the user of the item in the specific location to suppress erroneous operations.

However, when it is known that all users are accustomed with the currently selected display language (for example, Japanese), the item display transition unit 12 may transition the display (for example, in Japanese) of the item in the specific location only to another message expressed in the same display language (for example, Japanese) as that of the item. For example, the item may be changed to another message (“ [symbol] ”) expressed in the same display language (for example, Japanese) as the currently selected display language (for example, Japanese) at regular intervals, such as “ [symbol] ”→“ [symbol] ”→“ [symbol] ”, etc. In this case, the convenience of the user is enhanced even in the case of a PC (personal computer), a smartphone, a tablet, or the like in which a large number of display languages are stored in the operation panel 10.

Referring again to FIG. 2, it is preferable that the display system 1 further comprise a validity/invalidity indication unit 13 with which the user manually determines the validity or invalidity of the item display transition function. If all users are accustomed with the currently selected display language (for example, Japanese) and all users are known to be experts, since the item display transition function itself may be annoying to the user, the user can arbitrarily turn on/off the item display transition function, which further enhances the convenience of the user.

Furthermore, it is preferable that the display system 1 further comprise an item indication unit 14 with which the user manually assigns the item in the specific location. The user may want to change the display of not only items 40 to 42, which are related to the display language change setting, but also an item related to hazardous setting (for example, “frames”, “user frames”, etc.), which is described later, to, for example, another attention-attracting message (for example, “ [symbol] [symbol] ”, “TAKE CARE WITH SETTING”, etc.) or may want to change an item expressed in terminology (for example, in the field of robots, “ignore position correction command”) to another message that even beginners can easily understand (for example, “do not perform position correction with visual sensor”). Thus, the convenience of the user can be further improved by manually indicating the item in the specific location to be transitioned.

In this case, it is preferable that the display system 1 further comprise a message indication unit 15 with which the user manually determines the content of the message. In addition to the content of the message for guiding to the display language settings, the user may want to change the message content to, for example, another message content for attracting attention (for example, “ [symbol] ”, “TAKE CARE WITH SETTING”, etc.), which will be described later, or may want to change an item expressed in terminology (for example, “ignore position correction command”) to another message content that even beginners can easily understand (for example, “do not perform position correction with optical sensor”). Thus, the user can manually assign the content of the message, which further enhances the convenience of the user. The functions of validity/invalidity indication unit 13, the item indication unit 14, and the message indication unit 15 are realized by the processor of the operation panel 10, but may be realized by the processor of the controller 20 or the processor of an external computing device.

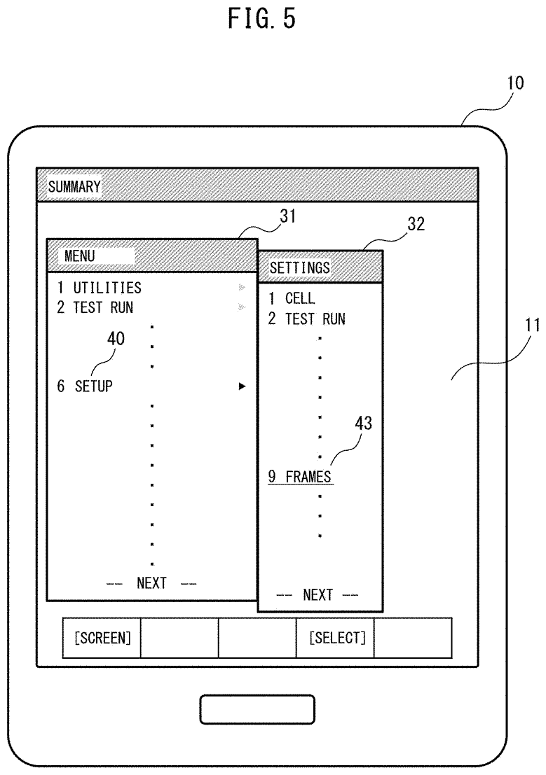

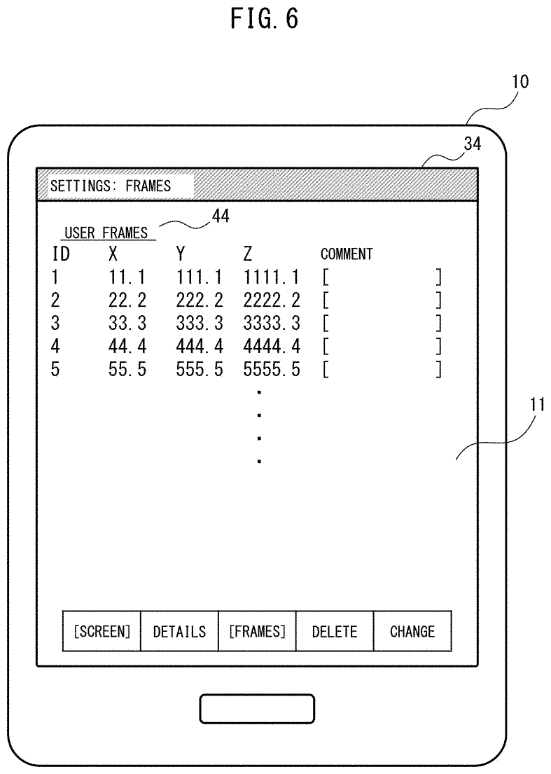

FIGS. 5 and 6 show examples of a screen displayed prior to reaching the setting of the user frames. When the “SETUP” item 40 in the specific location of the menu screen 31 shown in FIG. 5 is selected, the setting menu screen 32 is displayed, and when a “FRAMES” item 43 of the setting menu screen 32 is selected, a frames setting screen 34 shown in FIG. 6 is displayed, and the user frames can be set in a “USER FRAMES” item 44 of the frames setting screen 34. Specifically, items 43 and 44 are items related to hazardous setting.

For example, when the user frames ID “1” on the frames setting screen 34 shown in FIG. 6 is changed, the reference position of the machine 30 is changed, and accordingly, the operation path and the target position of the machine 30 are also changed when the program of the machine 30 is operated. It is very dangerous if the user is unfamiliar with the currently selected display language (for example, Japanese) because the setting of the user frames ID “1” can unintentionally be changed without knowing the display of the frames setting screen 34, and the machine 30 may perform an unexpected operation when the program is executed. Though hazardous setting is often a setting related to the operation of the machine 30 in this manner and is generally access-restricted for each user, the user who is unfamiliar with the currently selected display language (for example, Japanese) may make an erroneous operation, even if they are an authorized expert.

By applying the item display transition function to items related to settings that require sufficient attention in this manner, it is possible to suppress erroneous operations by the user. For example, based on the dictionary file 22 as shown in the following table, the item display transition unit 12 transitions the display of the “FRAMES” item 43 and the “USER FRAMES” item 44 underlined in FIGS. 5 and 6 to other messages (for example, “ [symbol] ” or “TAKE CARE WITH SETTING”) expressed in a stored display language (for example, Japanese, English, etc.).

TABLE 3

| | | | Japanese | | |
|---|---|---|---|---|---|
| Item ID | Japanese | English | message | English Message | ... |
| 0004 | [symbol] | FRAMES | [symbol] | TAKE CARE | ... |
| | | | | WITH SETTING | |
| 0005 | [symbol] | USER | [symbol] | TAKE CARE | ... |
| | | | | WITH SETTING | |
| | | FRAMES | | | |
| . | . | . | . | . | . |
| . | . | . | . | . | . |
| . | . | . | . | . | . |

When it is known that there are users who are unfamiliar with the currently selected display language (for example, Japanese), but who are accustomed with a language (for example, English) different than the display language (for example, Japanese), the item display transition unit 12 may transition the display (for example, in Japanese) of items 43 and 44 in the specific location to another message (“TAKE CARE WITH SETTING”, etc.) expressed in a display language (for example, English, etc.) different than that of the items. For example, the display of the “FRAMES” item 43 can be changed at a fixed interval, such as “ [symbol] ”→“TAKE CARE WITH SETTING”→“ [symbol] ”, etc. Thus, even when there are users who are unfamiliar with the currently selected display language (for example, Japanese) but who are accustomed with a language (for example, English) different from the display language (for example, Japanese), it can be understood that sufficient attention should be paid to the “FRAMES” item 43 and the “USER FRAMES” item 44.

Furthermore, if the native languages of the users are diverse (for example, Japanese, English, French, etc.), the item display transition unit 12 preferably transitions the display of the “FRAMES” item 43 and the “USER FRAMES” item 44 to other messages successively, which are expressed in all of the stored display languages, i.e., the displayable display languages (for example, “ [symbol] [symbol] ”, “TAKE CARE WITH SETTING”, “NOTEZ LE PARAMETRE”, etc.). For example, the display of the “FRAMES” item 43 is changed at a fixed interval to a message in each of the display languages, such as “FRAMES”→“ [symbol] ”→“TAKE CARE WITH SETTING”→“NOTEZ LE PARAMETRE”→“FRAMES”, etc. As a result, even if the user is unfamiliar with the currently selected display language (for example, Japanese), or if the user is accustomed with the display language (for example, Japanese) but simply fails to pay attention, it can be recognized that sufficient attention is required for the “FRAMES” item 43 and the “USER FRAMES” item 44.

When it is known that all users are accustomed with the currently selected display language (for example, Japanese), the item display transition unit 12 may transition the item (for example, in Japanese) in the specific location only to other messages expressed in the same display language (for example, Japanese) as that of the item For example, the item may be changed to another message (“ [symbol] ”) expressed in the same display language (for example, Japanese) as the currently selected display language (for example, Japanese), such as “ [symbol] ”→“ [symbol] ”→“ [symbol] ”, etc., at a fixed interval. In this case, the convenience of the user is enhanced even in the case of a PC (personal computer), a smartphone, a tablet, or the like in which a large number of display languages are stored in the operation panel 10.

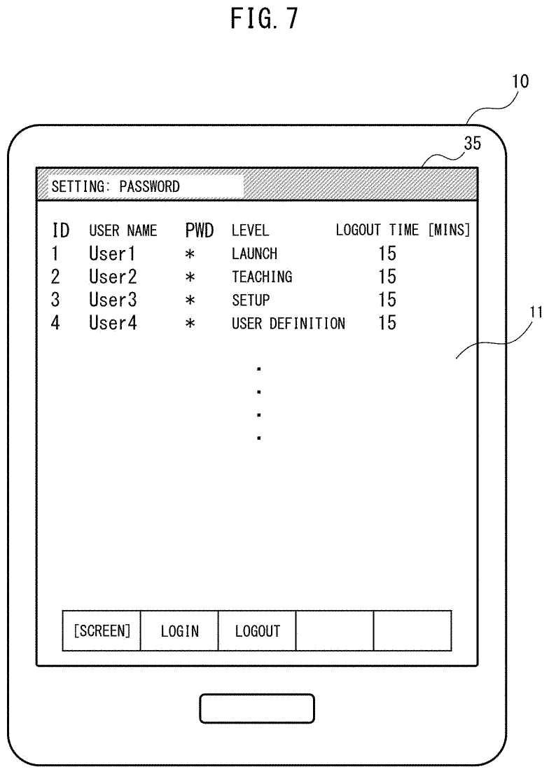

FIG. 7 shows an example of a screen for a user to login. In general, the same operation panel 10 and the same controller 20 are often shared by a plurality of users. In such a case, as methods of suppressing erroneous operations, a method of setting a level for each item that can be operated or edited, assigning a level (access restriction) to each user, and performing login authentication by a password are generally adopted. In a password setting screen 35 shown in FIG. 7, the user level (access restriction) setting, password setting, and login are executed. The following table shows user levels.

TABLE 4

| Level | Scope of actions which can be taken |
|---|---|
| LAUNCH | Can execute all actions; can change |
| | level setting of each user. |
| SETUP | Can change display and settings of |
| | screen for performing general setup |
| TEACHING | Can change display and setting of screen |
| | related to machine operation program |
| USER | Can change display and setting of screen |
| DEFINITION | depending on content separately defined by user |
| . | . |
| . | . |
| . | . |

By adopting the item display transition unit function described above, logged-in users can easily understand the items that they cannot operate. Though it is possible to hide access-restricted items themselves to improve readability, by intentionally shifting the display of access-restricted items to another message expressed in the stored display language, the user can easily recognize items that they cannot operate. For example, the item “SYSTEM CONFIG” is access-restricted according to the level of the user. In this example, only users at the “LAUNCH” level, “SETUP” level, and “USER DEFINITION” level can display or change the “SYSTEM CONFIG” item, while a user at the “TEACHING” level are not able to display or change the “SYSTEM CONFIG” item. At this time, the item display transition unit 12 preferably transitions the display of the “SYSTEM CONFIG” item, depending on the level of the logged-in user, to another message (for example, “ [symbol] ”, “NOT ALLOWED”, etc.) in a stored display language (for example, Japanese, English, etc.) based on, for example, the dictionary file 22 of the following table.

TABLE 5

| | | | Japanese | | |
|---|---|---|---|---|---|
| Level | Japanese | English | Message | English Message | ... |
| LAUNCH | [symbol] | SYSTEM | (No Transition) | (No Transition) | ... |
| | | CONFIG | | | |
| SETUP | [symbol] | SYSTEM | (No Transition) | (No Transition) | ... |
| | | CONFIG | | | |
| TEACHING | [symbol] | SYSTEM | [symbol] | NOT ALLOWED | ... |
| | | CONFIG | | | |
| USER | [symbol] | SYSTEM | (No Transition) | (No Transition) | ... |
| DEFINITION | | CONFIG | | | |
| . | . | . | . | . | . |
| . | . | . | . | . | . |
| . | . | . | . | . | . |

When it is known that there are users who are unfamiliar with the currently selected display language (for example, Japanese), but who are accustomed with a language (for example, English) different than the display language (for example, Japanese), the item display transition unit 12 only needs to transition the display (for example, in Japanese) of the “SYSTEM CONFIG” item to another message (“NOT ALLOWED”, etc.) expressed in a display language (for example, English, etc.) different than that of the item. For example, the display of the “SYSTEM CONFIG” item can be changed at a fixed interval, such as “ [symbol] ”→“NOT ALLOWED”→“ [symbol] [symbol] ”→“NOT ALLOWED”, etc. Thus, even when there are users who are unfamiliar with the currently selected display language (for example, Japanese) but who are accustomed with a language (for example, English) different from the display language (for example, Japanese), it can easily be recognized that the “SYSTEM CONFIG” item is access-restricted.

Furthermore, if the native languages of the users are diverse (for example, Japanese, English, French, etc.), the item display transition unit 12 preferably transitions the display of the “SYSTEM CONFIG” item to other messages successively, which are expressed in all of the stored display languages, i.e., the displayable display languages (for example, “ [symbol] ”, “NOT ALLOWED”, “INTERDIT”, etc.). For example, the “SYSTEM CONFIG” item can be changed at a fixed interval to a message in each of the display languages, such as “SYSTEM CONFIG”→“ [symbol] ”→“NOT ALLOWED”→“INTERDIT”→“SYSTEM CONFIG”→“ [symbol] [symbol] ”→“NOT ALLOWED”→“INTERDIT”, etc. As a result, even if the user is unfamiliar with the currently selected display language (for example, Japanese), or if the user is accustomed with the display language (for example, Japanese) but simply does not know whether the item is access-restricted, it can easily be understood that the item in specific location is access-restricted.

When it is known that all users are accustomed with the currently selected display language (for example, Japanese), the item display transition unit 12 may transition the display (for example, in Japanese) of the “SYSTEM CONFIG” item only to another message expressed in the same display language (for example, Japanese) as that of the item. For example, the item may be changed to another message (“ [symbol] ”) expressed in the same display language (for example, Japanese) as the currently selected display language (for example, Japanese), such as “ [symbol] [symbol] ”→“ [symbol] ”→“ [symbol] ”→“ [symbol] ”, etc., at a fixed interval. In this case, the convenience of the user is enhanced even in the case of a PC (personal computer), a smartphone, a tablet, or the like in which a large number of display languages are stored in the operation panel 10.

According to the embodiments above, it is possible to support user understanding of an item in a specific location and suppress erroneous operations regardless of the display language. In particular, in the operation panel 10 of a machine, the location of use is limited, and the number of display languages is generally limited. Thus, the item display transition function improves the convenience of the user.

Note that the program executed by the processor described above may be recorded and provided on a computer-readable non-temporary recording medium such as a CD-ROM, or alternatively, it may be distributed and provided from a server device on a WAN (wide area network) or LAN (local area network) via wired or wirelessly connectivity.

Though various embodiments have been described in the present description, the present invention is not limited to the embodiments described above, and it should be understood that various changes can be made within the scope described in the claims.

### REFERENCE SIGNS LIST

1 display system
10 operation panel
11 display unit
12 item display transition unit
13 validity/invalidity indication unit
14 item indication unit
15 message indication unit
20 controller
21 storage unit
22 dictionary file
30 machine
31 menu screen
32 setting menu screen
33 general features setting screen
34 frames setting screen
35 password setting screen
40 to 44 item

1. A display system, comprising:
a display unit for displaying a screen for performing setting or a status check,
a storage unit in which there is stored a dictionary file corresponding to display languages for display on the display unit, and
an item display transition unit for transitioning display of an item in a specific location on the screen to another message expressed in the stored display language.

2. The display system according to claim 1, wherein the item display transition unit transitions the display of the item in the specific location to all of the stored display languages.

3. The display system according to claim 1, wherein the item display transition unit transitions the item in the specific location to a message expressed in a display language different from that of the item or transitions the item to a message expressed in the same display language.

4. The display system according to claim 1, further comprising a validity/invalidity indication unit for indicating validity or invalidity of a function of the item display transition unit.

5. The display system according to claim 1, further comprising an item indication unit for indicating the item in the specific location.

6. The display system according to claim 1, further comprising a message indication unit for indicating content of the message.

7. The display system according to claim 1, wherein the item in the specific location is an item related to a display language change setting, an item related to a hazardous setting, an item which is access restricted depending on the level of the user, or an item expressed in terminology.

8. The display system according to claim 7, wherein the hazardous setting is a setting related to operation of a machine.

9. The display system according to claim 7, wherein the item display transition unit transitions the display of the item in the specific location for a plurality of the screens until the setting is reached.

10. The display system according to claim 1, wherein the display unit is provided on an operation panel of a machine, and the storage unit is provided in a controller of the machine.
